(19) United States
(12) Patent Application Publication
(10) Pub. No.: US 2023/0298074 A1
(43) Pub. Date: Sep. 21, 2023

(54) ANALYSIS AND RECOMMENDATION SYSTEMS, AND RELATED METHODS AND COMPUTER-READABLE MEDIA

(71) Applicant: Micron technology, Inc., Boise, ID (US)

(72) Inventors: Diana C. Majerus, Boise, ID (US); Brenda D. Kraus, Boise, ID (US); Ying Zhang, Boise, ID (US); Soo Koon Ng, Boise, ID (US)

(21) Appl. No.: 17/655,126

(22) Filed: Mar. 16, 2022

(51) Int. Cl. G06Q 30/02; H04W 4/029

(52) U.S. Cl. CPC G06Q 30/0282; G06Q 30/0204; H04W 4/029

(57) ABSTRACT

Methods of generating a recommendation for a user based at least partially on one or more reoccurring financial transaction events and a determined amount of user activity are disclosed. A method may include monitoring spending data for a user, and identifying, based at least partially on the spending data, one or more reoccurring financial transaction events. The method may also include identifying one or more user services based on the one or more reoccurring financial transaction events, and determining an amount of user activity for the user related to at least one user service of the one or more user services. Further, the method may include generating, and providing to a user, a recommendation related to the at least one user service based at least partially on the determined amount of user activity. Related systems and computer-readable media are also disclosed.

### TECHNICAL FIELD

This disclosure relates generally to financial management, and more specifically to providing financial-based recommendations to a user. Yet more specifically, various embodiments relate to analyzing usage of subscriptions and/or memberships, and providing recommendations to a user. Related methods, systems, and computer-readable media are also disclosed.

### BACKGROUND

Subscription and membership models are becoming increasingly common as a method for merchants to offer services, products, and/or access to a community and/or equipment. These models, wherein customers may agree to pay a regular fee (e.g., weekly, monthly, or annual) in exchange for regular, continuous access to, for example, a service, a product, a community, and/or equipment, may be useful and advantageous for both merchants and customers. Merchants may rely on a regular and predictable flow of revenue, while customers receive regular access to services and/or products without the hassle of reordering or re-paying each time they access or a receive a product or a service. However, it may not be worthwhile for a customer to pay a regular fee for a service, a product, or access that the customer does not regularly use. Furthermore, it may be difficult for a customer to realize that the cost of a subscription or a membership is not justified without performing a complex cost-use analysis. Additionally, it may be inconvenient, cumbersome, and/or difficult to cancel or adjust memberships or subscriptions, whether or not the service is unused or underused.

### BRIEF DESCRIPTION OF THE SEVERAL VIEWS OF THE DRAWINGS

Various embodiments will be described and explained with additional specificity and detail through the use of the accompanying drawings in which:

FIG. 1 illustrates a schematic diagram of an example environment in which an analysis system may operate according to one or more embodiments of the disclosure;

FIG. 2 is a flowchart of an example method of providing a recommendation to a user regarding a service, in accordance with various embodiments of the disclosure;

FIG. 3 is a flowchart of another example method, in accordance with one or more embodiments of the disclosure;

FIG. 4 is a flowchart of yet another example method, in accordance with one or more embodiments of the disclosure; and

FIG. 5 is a block diagram of an exemplary computing device that may be configured to perform one or more of the embodiments of the disclosure.

### DETAILED DESCRIPTION

The illustrations presented herein are not actual views of any particular analysis system, or any component thereof, but are merely idealized representations, which are employed to describe the present disclosure.

As used herein, the singular forms following “a,” “an,” and “the” are intended to include the plural forms as well, unless the context clearly indicates otherwise.

As used herein, the term “may” with respect to a material, structure, feature, function, or method act indicates that such is contemplated for use in implementation of an embodiment of the disclosure, and such term is used in preference to the more restrictive term “is” so as to avoid any implication that other compatible materials, structures, features, functions, and methods usable in combination therewith should or must be excluded.

As used herein, any relational term, such as “first,” “second,” etc., is used for clarity and convenience in understanding the disclosure and accompanying drawings, and does not connote or depend on any specific preference or order, except where the context clearly indicates otherwise.

As used herein, the term “substantially” in reference to a given parameter, property, act, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

One or more embodiments of the present disclosure include an analysis system (also referred to herein as an “analysis and recommendation system” or a “recommendation system”) that receives spending and/or location data for a user, and after analyzing the spending and/or location data, provides a recommendation to the user (e.g., to adjust a financial behavior). More specifically, according to some embodiments, an analysis system may monitor financial transactions for a user, and identify, based at least partially on the financial transactions, one or more user services associated with one or more reoccurring financial transactions. Further, the analysis system may determine an amount of user activity associated with the one or more user services. Moreover, the analysis system may generate and provide to a user, a recommendation based at least partially on the amount of user activity associated with the one or more user services.

For example, in some embodiments, an application (e.g., on a client device, such as a smartphone) may track or monitor a user's location and compare that location with transaction data to determine where a particular transaction occurred. Furthermore, in some embodiments, an application (e.g., on a client device) may track or monitor usage of a particular service (e.g., a subscription or a membership) by the user to determine whether the cost of the service to the user is justified.

In some embodiments, an analysis system may analyze a user's transactions and locations substantially in real time and provide feedback (e.g., immediate feedback) with recommendations for the user to, for example, continue with positive behavior and/or to stop negative financial behavior (e.g., unbudgeted purchases). In one or more embodiments disclosed herein, the analysis system may provide a report containing analysis and recommendations for the user (e.g., after a pre-determined period of time has passed).

Because the analysis system of the present disclosure may enable a user to reliably and efficiently receive information related to financial behavior and/or services (e.g., subscription and/or membership services), the analysis system is advantageous over conventional systems. For instance, because the analysis system may enable a user to receive recommendations regarding several subscriptions, memberships, and/or merchants while using a single system instead of accessing the data through multiple services and/or merchants, the analysis system may reduce required processing power, memory, and communication resources needed to facilitate receiving recommendations for financial behavior. Accordingly, the analysis system may result in less data transfer and data bandwidth usage for a computer/communication system. In other words, the analysis system may result in less required processing power and communication bandwidth in comparison to conventional systems. As a result, the analysis system of the present disclosure, in comparison to conventional systems, may be a more appropriate system for mobile devices. Additionally, in view of the foregoing, the analysis system may result in a more user-friendly, consistent, attractive, and persuasive method for determining financial behavior and/or providing recommendations in comparison to conventional financial management systems.

Furthermore, because the analysis system of the present disclosure enables a user to quickly and efficiently track or monitor geolocation, spending, and subscription and/or membership usage, resulting in real-time or deferred financial and/or service-based recommendations, the analysis system of the present disclosure may provide greater access (e.g., access to the public) for financial management tools including subscription and/or membership service management and determining cost-justifications for services (e.g., subscription and/or membership services). As a result of the improvements disclosed herein, a user may not need to take time to personally analyze services and usage of the services to determine cost-justification, resulting in significant time and cost savings to the user.

In one or more embodiments, a client device and/or a third party system may perform some or all of the analysis that is discussed in the present disclosure, without the need for and use of a separate analysis system. Accordingly, any time a process or action is discussed in the present disclosure as being completed or performed by an analysis system, it is specifically contemplated that the process or action may be completed or performed by an analysis system, or by a client device and/or a third party system and not necessarily by an analysis system.

It is noted that, in addition to including subscription type services (e.g., streaming services, meal planning/delivery services, online media services, home security services, etc.), the term “subscription” as used herein may include membership type services (e.g., gym or spa memberships, country club memberships, retail store memberships, etc.). Further, in addition to including membership type services (e.g., gym or spa memberships, country club memberships, retail store memberships, etc.), the term “membership” as used herein may include subscription type services (e.g., streaming services, meal planning/delivery services, online media services, home security services, etc.). Moreover, in some examples, the term “services” may include subscription type services, membership type services, or both.

Embodiments of the disclosure will now be explained with reference to the accompanying drawings.

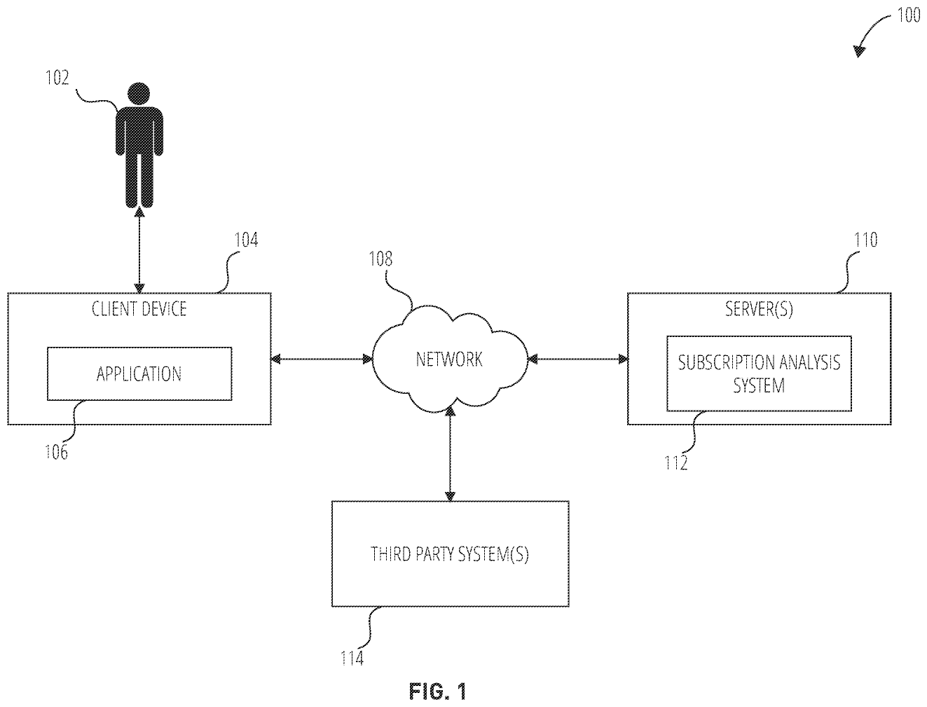

FIG. 1 illustrates a schematic diagram of an environment 100 in which an analysis system may operate according to one or more embodiments of the present disclosure. As illustrated, the environment 100 includes a client device 104, at least one server 110 including an analysis system 112, a network 108, and one or more third party system(s) 114.

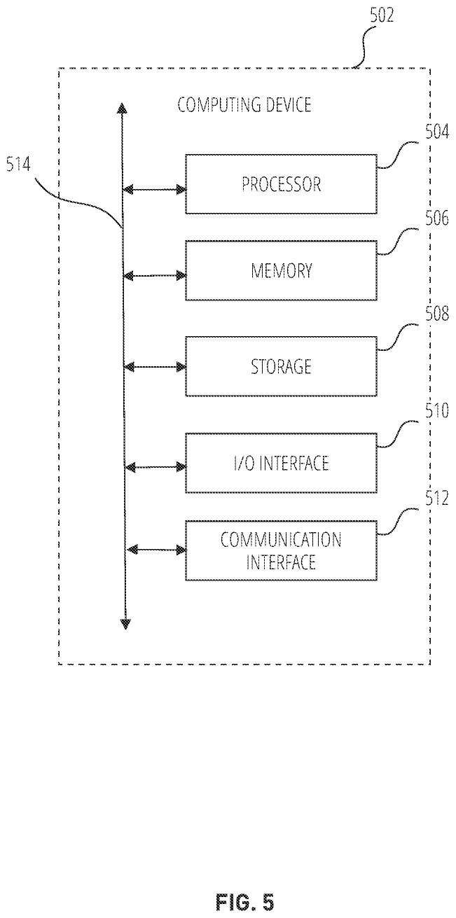

According to some embodiments, as used herein, the phrase “analysis system” may refer to a system that analyzes a one or more services (e.g., subscription and/or a membership (e.g., a monthly or annual membership with recurring fees) for a user based on obtained information such as, for example, spending data, subscription/membership data (e.g., amount of time spent using a membership or subscribed-to service), location data, etc., and provides one or more recommendations to the user. Further, in some embodiments, “analysis system” may refer to a system that performs financial analysis of a user's actions and/or transactions and provides one or more recommendations to the user. In some embodiments, one or more functions of the analysis system 112 may be performed by a computing device, such as a computing device 502, described more fully below with reference to FIG. 5.

In some embodiments, as is described in greater detail below, the analysis system 112 may monitor and/or analyze a user's (e.g., user 102) spending data and a user's geolocations to determine and provide a recommendation for the user to cancel a particular service that is being unused or underused. For instance, the analysis system 112 may determine that the user does not visit a gym where the user has a membership and may recommend that the gym membership be canceled. As another example, the analysis system 112 may determine that the user does not use a streaming service and may recommend that a subscription to the streaming service be canceled.

The client device 104 may be any one or more of various types of computing devices. For example, the client device 104 may include a mobile device such as a mobile telephone, a smartphone, a personal digital assistant (PDA), a tablet, a laptop, a smart speaker (e.g., AMAZON ECHO, GOOGLE HOME, APPLE HOMEPOD, etc.) or a non-mobile device such as a desktop computer or another type of computing device. Additional details with respect to the client device 104 are discussed below with respect to FIG. 5.

In some embodiments, the client device 104 may include an application 106 for tracking spending, location, and subscription/membership data and for facilitating communication between the user 102 and/or the client device 104 and the third party system(s) 114 and/or the analysis system 112. In particular, the client device 104 may execute one or more applications (e.g., the application 106) for performing various embodiments described herein. For example, in some instances, the application 106 may be a financial tracking application that tracks spending by the user 102, a location of the user 102, actions by the user 102, and/or services that the user 102 is subscribed and/or belongs to (e.g., user services), while providing analysis and recommendations as to financial choices of the user 102.

For example, the user 102 may have a membership at a gym or other fitness facility and may permit the client device 104 to passively track a location of the user 102 and the financial information including spending data associated with the user 102. The application 106, via client device 104, may send geolocation data (e.g., the tracked geolocation of the client device 104) for the user 102 to the analysis system 112. The application 106 may provide push notifications to the client device 104 for display to the user 102. The push notifications may include notifications of positive behavior, such as utilizing a subscription or a membership sufficiently or avoiding poor spending habits.

The application 106 may also include data protection measures such as encryption and password or passcode protection to access sensitive information in the application 106. The application 106 may include data sharing and remote access to server(s) 110. The application 106 may also receive input from the user 102 regarding subscriptions and/or memberships and financial institutions at which the user 102 is a customer. The data input by the user 102 may be stored at the server(s) 110, and the application 106, as part of the client device 104, may retrieve the stored data any time the user 102 accesses and/or logs into the application 106 or at any other time.

The third party system(s) 114 may include additional systems that interface with the client device 104 and the analysis system 112. For example, in some embodiments, the third party system(s) 114 may include financial institutions (e.g., banks, credit unions, savings and loan associations, insurance companies, investment companies, etc.) and/or user services (e.g., video/audio/gaming streaming services, news and/or other media outlet services, cloud storage services, software services, retail services, home fitness services, smart home services, home security services, financial institution services, gym memberships services, car wash services, retail food establishment services, country club membership services, etc.).

In one or more embodiments, the third party system(s) 114 may receive requests for data from the client device 104 and may provide the requested data to the client device 104, additional third party systems 114, and/or the analysis system 112. In additional embodiments, the third party system(s) 114 may receive requests directly from the analysis system 112 for data associated with the user 102. For example, the analysis system 112 may send a request to a financial institution where the user 102 holds an account to retrieve transaction data for an account for the user 102 (e.g., for a set period of time). The financial institution, an example of the third party system 114, may provide the requested data to the analysis system 112, assuming the user 102 had previously or concurrently authorized the release of the data. As another non-limiting example, the analysis system 112 may send a request to a service to which the user 102 is subscribed to (or belongs to) to retrieve data regarding usage of the service by the user 102. Furthermore, the third party system(s) 114 may automatically communicate information related to the user 102 to the analysis system 112 or the client device 104 without a specific request.

The analysis system 112, the client device 104, and/or the third party system(s) 114 may communicate via the network 108. In one or more embodiments, the network 108 includes a combination of cellular or mobile telecommunications networks, a public switched telephone network (PSTN), and/or the Internet or World Wide Web and facilitates the transmission of messages between the client device 104 and the analysis system 112. The network 108, however, may include various other types of networks that use various communication technologies and protocols, such as wireless local area network (WLAN), a local area network (LAN), a wide area network (WAN), a metropolitan area network (MAN), other telecommunication networks, or a combination of two or more of the foregoing networks. Although FIG. 1 illustrates a particular arrangement of the client device 104, the server(s) 110, the third party system(s) 114, and the network 108, various additional arrangements are possible. For example, the server(s) 110 and, accordingly, the analysis system 112, may directly communication with the client device 104, bypassing the network 108.

As illustrated in FIG. 1, the user 102 may interface with the client device 104, for example, to communicate with the server(s) 110 and to utilize the analysis system 112 to receive recommendations from the analysis system 112, as how to alter financial behavior or to alter the use of unused or underused services. The user 102 may be an individual (i.e., a human user), a business, a group or any other entity. Although FIG. 1 illustrates only one user 102 associated with the client device 104, the environment 100 may include any number of users that each interact with the environment 100 using a corresponding client device. For instance, the analysis system 112 may service multiple client devices 104 and users 102.

In some embodiments, the analysis system 112 may include one or more systems, servers, and/or other devices for analyzing and determining recommendations for the user 102. The analysis system 112 may include and/or have access to one or more databases. For example, in some embodiments, the analysis system 112 may be implemented by a number of server devices that store, within the one or more databases, user financial information and/or facilitate querying any of the foregoing information and content to provide recommendations to the user 102 regarding financial behavior, including without limitation, subscription and/or membership services.

As discussed in greater detail below, in some embodiments, the analysis system 112 may maintain thresholds for what may constitute value or worth for a service. In other words, the analysis system 112 may algorithmically determine whether the user 102 is utilizing a service (e.g., a subscription or a membership) sufficiently such that the cost of the service is justified. The analysis system 112 may also be enabled to assist the user 102 with adjusting or cancelling a service by communicating directly with the third party system(s) 114 which provides the service. In this manner, the interaction between the user 102 and the third party system(s) 114 providing services may be decreased and/or limited.

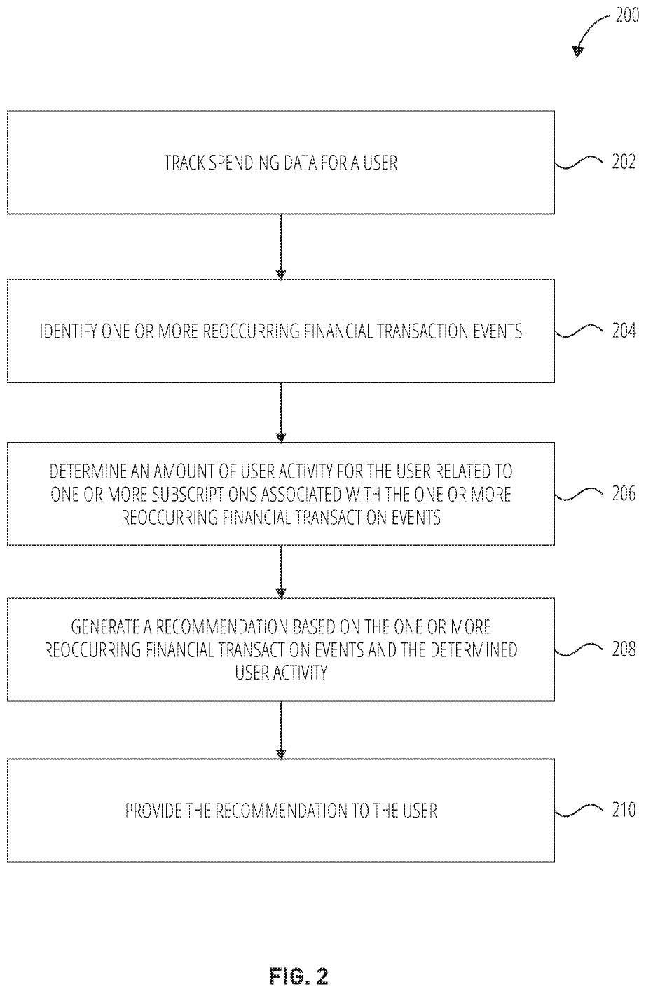

FIG. 2 is a flowchart of an example method 200 of providing a recommendation to a user regarding a service, in accordance with various embodiments of the disclosure. The method 200 may be arranged in accordance with at least one embodiment described in the disclosure. The method 200 may be performed, in some embodiments, by a device or system, such as the client device 104 of FIG. 1, the analysis system 112 of FIG. 1, the computing device 502 of FIG. 5, and/or another device or system. Although illustrated as discrete blocks, various blocks may be divided into additional blocks, combined into fewer blocks, or eliminated, depending on the desired implementation.

The method 200 may begin at block 202 wherein spending data for a user (e.g., user 102 of FIG. 1) may be tracked. For example, spending data may include bank statements and/or credit/debit card statements showing transaction data including individual transactions. The spending data may also include data provided by a financial institution (e.g., substantially in real time) including transaction data. For example, the transaction data may include an amount spent by the user in one or more transactions, an indication of merchant(s) where the one or more transactions occurred, physical locations of the one or more transactions, a date and time of each of the one or more transactions, etc.

At block 204, one or more user services may be identified based on one or more reoccurring financial transaction events. A reoccurring financial transaction event may include a regular and/or periodic payment to a particular merchant. For example, in some embodiments, factors that may indicate a reoccurring financial transaction event may include a monthly payment to the same merchant, payment tendered around the same time each month, and/or a fixed or very similar amount tendered in each transaction. In one or more embodiments, the reoccurring or recurring financial transaction may be identified as and determined to be a transaction to cover a cost of a membership or subscription to a recurring user service or product. In some embodiments, the user service may be identified via a name of a merchant obtained from reoccurring financial transaction event data.

At block 206, an amount of user activity related to the one or more user services (e.g., subscription and/or membership services) may be determined. The amount of user activity may be an amount of time spent by the user using a service or product associated with the subscription and/or membership (e.g., the frequency of use and/or duration of use of a user service). The amount of user activity may also be the number of visits the user made to a location of the user service or product. The amount of user activity may further relate to the number of times the user logged into or accessed a service or product online. In some example, the amount of user activity may be determined responsive to data provided directly by a merchant that provided the service or product (e.g., third party system(s) 114 of FIG. 1). In some embodiments, the amount of user activity may also be determined responsive to input from the user (e.g., through the application 106 of client device 104 of FIG. 1).

At block 208, a recommendation based on the one or more reoccurring financial transaction events and the determined user activity is generated and/or determined. The generated recommendation may include a recommendation to increase use of a subscription or membership service, adjust the subscription or membership service (e.g., change the subscription or membership to a less costly option with more limited services, if applicable), or to cancel the subscription or membership service altogether. An analysis system (e.g., the analysis system 112 of FIG. 1) that determines and/or generates the recommendation may maintain various thresholds (e.g., minimum thresholds and/or minimum threshold levels) that may be used to determine whether the cost of the subscription or membership is justified based on the amount of user activity. For example, the thresholds may be adjusted responsive to user feedback.

By way of non-limiting example, an analysis system, such as the analysis system 112 of FIG. 1, may determine that, responsive to usage data and financial transaction history and data, a user (e.g., the user 102 of FIG. 1) should be using a particular service a minimum number of hours each month to justify the cost of the subscription. Or in another non-limiting example, the analysis system may determine that the user should be making a minimum number of visits to a location (e.g., gym) where the user holds a membership such that the cost of the membership is justified. If the user does not use a subscription or membership service sufficiently and/or visit a location a sufficient number of times, then the analysis system may generate a recommendation to adjust or cancel the subscription/membership service, or alternatively, a recommendation to adjust (e.g., increase) the use of the subscription or membership service. In one or more embodiments, the analysis system may use machine learning or artificial intelligence to determine the thresholds for what may constitute a justified subscription or membership, by comparing usage and transaction history of the user with the usage and transaction history of the user and other users who may be subscribed or belong to the same or similar services to determine proper thresholds for decision-making.

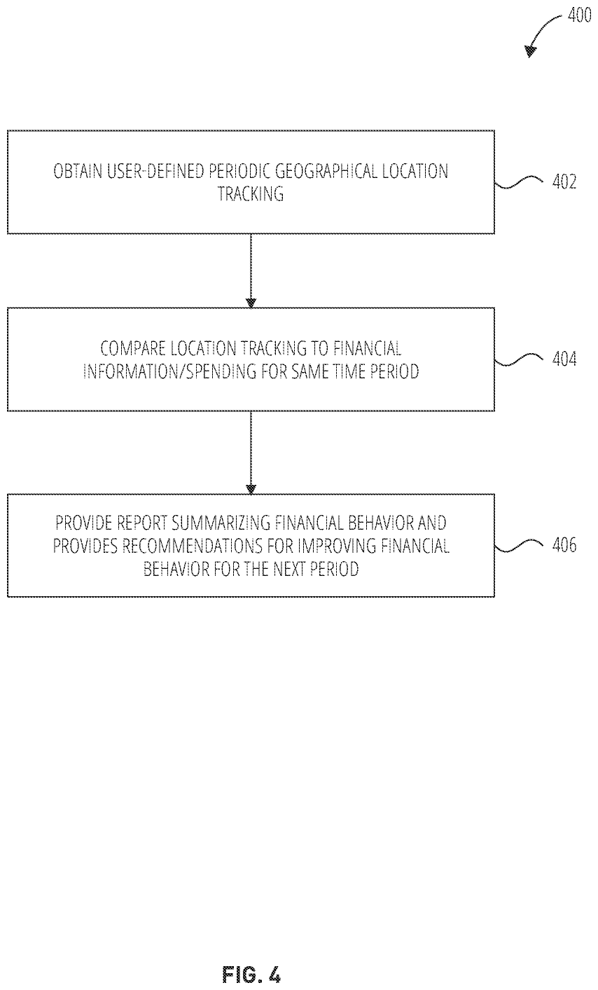

At block 210, the generated recommendation may be provided to the user. For example, the analysis system may provide the recommendation over a network (e.g., network 108 of FIG. 1) to a client device (e.g., client device 104). The client device may display the recommendation, in some embodiments, through an application, such as application 106 of FIG. 1. The recommendation may be displayed as a push notification or it may be displayed upon request by the user while interacting with the application. In one or more embodiments, the recommendation may be included in a report that is sent (e.g., on a periodic basis) to the user (e.g., in a monthly email to the user, as discussed in more detail below with respect to FIG. 4).

Modifications, additions, or omissions may be made to the method 200 without departing from the scope of the disclosure. For example, the operations of the method 200 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

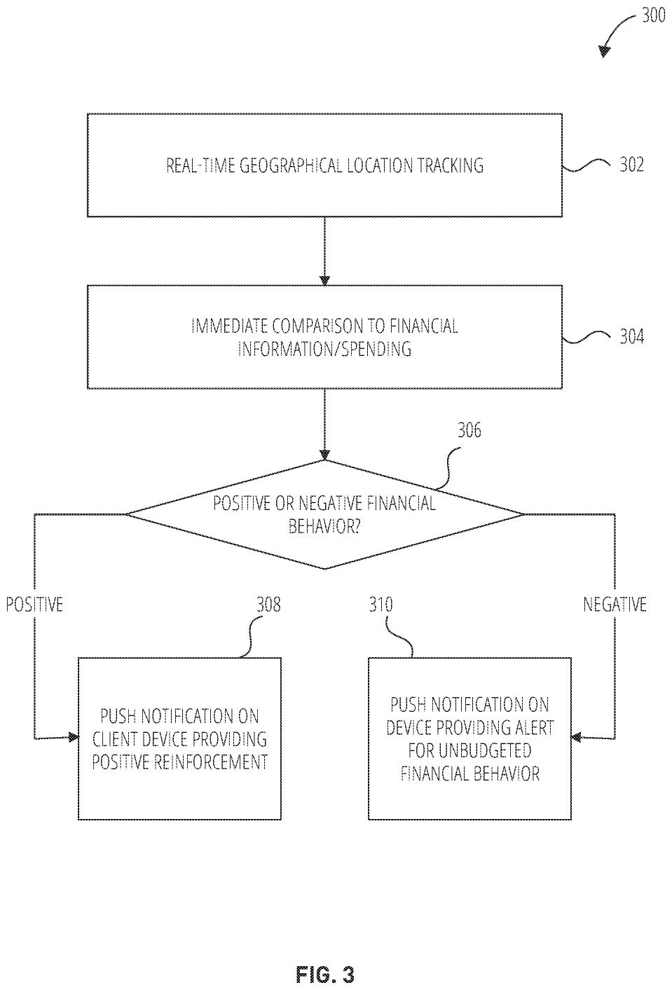

FIG. 3 is a flowchart of an example method 300, in accordance with one or more embodiments of the present disclosure. The method 300 may be arranged in accordance with at least one embodiment described in the disclosure. The method 300 may be performed, in some embodiments, by a device or system, such as the client device 104 of FIG. 1, the analysis system 112 of FIG. 1, the computing device 502 of FIG. 5, and/or another device or system. In some embodiments, the method 300 may be associated with real-time enforcement of financial behavior. Although illustrated as discrete blocks, various blocks may be divided into additional blocks, combined into fewer blocks, or eliminated, depending on the desired implementation.

The method 300 may begin at block 302, wherein geographical location for a user is tracked. The geographical location (e.g., a “geolocation”) of the user, such as the user 102 of FIG. 1, may be performed by tracking (e.g., in real-time) a mobile device, such as the client device 104 of FIG. 1. It may be assumed that the user will carry the client device and/or the client device will generally be in the same or similar location as the user. The client device may be tracked using a cell signal, by Global Positioning System (GPS), by a combination of the cell signal and GPS, or by any other suitable method. The geolocation information may be transmitted (e.g., in real-time) by the client device to an analysis system (e.g., analysis system 112 of FIG. 1) or any other interested third party system(s), such as third party system(s) 114 of FIG. 1. In some embodiments, the user may be required to grant permission to the client device and/or an application (e.g., application 106 of FIG. 1) to share the geolocation in real time with the analysis system and/or the third party system(s). In one or more embodiments, the user may grant limited permission to share a geolocation only some of the time or at certain times during the day.

At block 304, the geographical location of the user may be compared (e.g., immediately) to financial information and/or spending data for the user. As described above with respect to block 202 of FIG. 2, the analysis system may receive transaction and spending data associated with the user. Financial information, including the transaction data and the spending data, may be stored on one or more servers (e.g., server(s) 110 of FIG. 1). The financial information may be monitored and/or analyzed to identify trends for the user, including reoccurring financial transactions that may be for subscription and/or membership services. The financial information may also be analyzed to identify other kinds of trends that may be unrelated to specific subscription or membership services, such as, for example, trends of dining out, online shopping, or entertainment. The financial information may contain location information of particular merchants related to particular transaction events. In some embodiments, the analysis system may determine the location of each transaction event based on the received geolocation data by comparing the timing of the transaction, and the geolocation of the user at the time of the transaction event. In other words, the geolocation and the transactions are correlated to determine when and where a transaction event occurred.

For example, the analysis system may compare the geolocation data and financial information including transaction event data with an online map service (e.g., Google Maps, Apple Maps, etc.) to identify trends and determine when and where the user tends to make purchases. Furthermore, the analysis system may determine which trends of the user are exemplary of positive financial behavior (e.g., behaviors that are budgeted and/or save money) and which are negative (e.g., unbudgeted behaviors, behaviors that do not save money, behaviors that misuse money, etc.). As such, the analysis system may determine that, based on the comparison between the financial information and the geolocation data, the user is currently exhibiting positive or negative behavior, as shown in decision block 306 of the method 300. A non-limiting example of positive behavior may be that the user drove past without stopping at a fast-food restaurant that the user has a habit of frequenting at a particular time of day.

At block 308, positive reinforcement for positive financial behavior may be provided to the user. For example, the user may receive a push notification (e.g., on the client device) providing positive reinforcement for the positive financial behavior. In this example, the analysis system has determined that the financial behavior currently exhibited by the user is positive. For instance, if the user drives past an oft-visited fast-food restaurant without stopping to buy food, and by doing so, breaks with the trend to stop and buy unhealthy and/or expensive food, a push notification may appear on the client device with words of encouragement for the user, perhaps congratulating the user for driving past the restaurant without stopping.

At block 310, an alert indicating negative financial behavior may be provided to the user. For example, the user may receive a push notification (e.g., on the client device) providing the alert indicating negative financial behavior. The application may include a budgeting application which the user may use to make plans to limit spending and consumption of unnecessary services and products. The analysis system may, responsive to the real-time geographical location tracking and the comparison to financial information and spending, analyze and determine that a financial transaction event is not budgeted and therefore is a negative financial behavior. A push notification may be provided on the client device alerting the user of the negative (e.g., unbudgeted) behavior and reminding the user to refrain from taking such actions in the future. The analysis system may anticipate unbudgeted spending based on the geolocation and the historical spending habits for the user for a particular location. The user may also receive notifications that a particular transaction was classified as a “high-cost” purchase, which was perhaps unnecessary and/or excessive.

Modifications, additions, or omissions may be made to the method 300 without departing from the scope of the disclosure. For example, the operations of the method 300 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIG. 4 is a flowchart of an example method 400, in accordance with one or more embodiments of the present disclosure. The method 400 may be arranged in accordance with at least one embodiment described in the disclosure. The method 400 may be performed, in some embodiments, by a device or system, such as the client device 104 of FIG. 1, the analysis system 112 of FIG. 1, the computing device 502 of FIG. 5, and/or another device or system. In some embodiments, the method 400 may be associated with real-time enforcement of financial behavior. Although illustrated as discrete blocks, various blocks may be divided into additional blocks, combined into fewer blocks, or eliminated, depending on the desired implementation.

The method 400 may begin at block 402, wherein geographical location data for a user (e.g., user 102 of FIG. 1) for a time period is obtained and/or generated. The geographical location data may be stored by a client device (e.g., client device 104 of FIG. 1) or by a third party system(s) (e.g., third party system(s) 114 of FIG. 1) until a user-defined time period has passed, at which point the analysis system may obtain the geographical location data from the client device or the third party system(s). The user may define the period of time to be a regular period of time, such as, for example, one week, one month, or one quarter of a year, without limitation. With reference to FIG. 1, the client device 104 may track the location of the user 102 and the application 106 may keep track of the locations visited and the amount of time the user 102 stayed at various locations.

At block 404, the geographical location data may be compared to financial information/spending data for the user for the same time period. The spending data, as discussed above, may include timestamps for the credit card or debit card transactions, which may be compared and correlated to the date and time that the user may have visited particular locations. In other words, the analysis system may analyze the geographical location data and the spending data to determine the geolocation of the user at any time that a transaction event occurred.

At block 406, a report summarizing financial behavior and recommendations for improving financial behavior (e.g., for a subsequent time period) is provided. The report may be provided to the user via email, via the application on the client device, via text message on the client device, etc. In some embodiments, the user may be notified that a report is available to view on a website or an application, such as the application 106 of FIG. 1. The notification that a report is available may be through email, text message, push notification, or through any other suitable means.

The analysis system may also determine recommendations for improvement (e.g., during the subsequent time period), based on the habits, trends, and/or behaviors of the user during the previous time period(s). Recommendations for improvement may include limiting or cancelling unused or underused subscriptions or memberships, lowering the budgeted amount available for particular categories, and other specific recommendations, such as reducing the frequency of dining out. The report may include a detailed list of all transactions made during the time period and the location of the user at the time of each of the transactions. The analysis system may use machine learning to identify trends and behaviors associated with the user so that the analysis system produces relevant and effective recommendations that may be useful to the user. The report may include a cost/use analysis that the user can use to determine which transactions and purchases were justified and how the user can improve in the future.

Modifications, additions, or omissions may be made to the method 400 without departing from the scope of the disclosure. For example, the operations of the method 400 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIG. 5 is a block diagram of an exemplary computing device 502 that may be utilized as a client device (e.g., the client device 104) and/or an analysis system (e.g., the analysis system 112 of FIG. 1) that may be configured to perform one or more of the processes described above. One will appreciate that one or more computing devices may implement the computing device 502. The computing device 502 can comprise a processor 504, a memory 506, a storage device 508, an I/O interface 510, and a communication interface 512, which may be communicatively coupled by way of communication infrastructure 514. While an exemplary computing device is shown in FIG. 5, the components illustrated in FIG. 5 are not intended to be limiting. Additional or alternative components may be used in other embodiments. Furthermore, in certain embodiments, the computing device 502 may include fewer components than those shown in FIG. 5. Components of the computing device 502 shown in FIG. 5 will now be described in additional detail.

In one or more embodiments, the processor 504 includes hardware for executing instructions, such as those making up a computer program. As an example and not by way of limitation, to execute instructions, the processor 504 may retrieve (or fetch) the instructions from an internal register, an internal cache, the memory 506, or the storage device 508 and decode and execute them. In one or more embodiments, the processor 504 may include one or more internal caches for data, instructions, or addresses. As an example not by way of limitation, the processor 504 may include one or more instruction caches, one or more data caches, and one or more translational lookaside buffers (TLBs). Instructions in the instruction caches may be copies of instructions in the memory 506 or the storage device 508.

The computing device 502 includes the memory 506, which is coupled to the processor(s) 504. The memory 506 may be used for storing data, metadata, and programs for execution by the processor(s). The memory 506 may include one or more of volatile and non-volatile memories, such as Random-Access Memory (“RAM”), Read-Only Memory (“ROM”), a solid state disk (“SSD”), Flash, Phase Change Memory (“PCM”), or other types of data storage. The memory 506 may be internal or distributed memory.

The computing device 502 includes the storage device 508 that includes storage for storing data or instructions. As an example, and not by way of limitation, the storage device 508 can comprise a non-transitory storage media described above. The storage device 508 may include a hard disk drive (HDD), a floppy disk drive, Flash memory, an optical disc, a magneto-optical disc, magnetic tape, or a Universal Serial Bus (USB) drive or a combination of two or more of these. The storage device 508 may include removable or non-removable (or fixed) media, where appropriate. The storage device 508 may be internal or external to the computing device 502. In one or more embodiments, the storage device 508 is non-volatile, solid-state memory. In other embodiments, the storage device 508 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or Flash memory or a combination of two or more of these.

The computing device 502 also includes one or more input or output (“I/O”) devices/interfaces 510, which are provided to allow a user (e.g., the user 102 of FIG. 1) to provide input to, receive output from, and otherwise transfer data to and receive data from the computing device 502. The I/O devices/interfaces 510 may include a mouse, a keypad or a keyboard, a touch screen, a camera, an optical scanner, network interface, modem, other known I/O devices or a combination of such I/O device/interfaces. The touch screen may be activated with a stylus or a finger.

The I/O devices/interfaces 510 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 510 is configured to provide graphical data to a display for presentation to a user. The graphical data may be representative of one or more graphical user interfaces and/or any other graphical content as may serve a particular implementation.

The computing device 502 can further include the communication interface 512. The communication interface 512 can include hardware, software, or both. The communication interface 512 can provide one or more interfaces for communication (such as, for example, packet-based communication) between the computing device 502 and one or more other computing devices or networks. As an example, and not by way of limitation, the communication interface 512 may include a network interface controller (NIC) or network adapter for communicating with an Ethernet or other wire-based network or a wireless NIC (WNIC) or wireless adapter for communicating with a wireless network, such as a Wi-Fi.

Additionally or alternatively, the communication interface 512 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 512 may facilitate communications with a wireless PAN (WPAN) (such as, for example, a BLUETOOTH®WPAN), a Wi-Fi network, a WI-MAX network, a cellular telephone network (such as, for example, a Global System for Mobile Communications (GSM) network), or other suitable wireless network or a combination thereof.

Additionally, the communication interface 512 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 514 may include hardware, software, or both that couples components of the computing device 502 to each other. As an example and not by way of limitation, the communication infrastructure 514 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

According to various embodiments, a method may include monitoring spending data for a user in substantially real time, and identifying, based at least partially on the spending data, one or more reoccurring financial transaction events. The method may also include identifying one or more user services based on the one or more reoccurring financial transaction events, and determining an amount of user activity for the user related to at least one user service of the one or more user services. Further, the method may include generating, and providing to a user, a recommendation related to the at least one user service based at least partially on the determined amount of user activity.

In accordance with various embodiments, a system may include at least one processor and at least one non-transitory computer-readable storage media storing instructions thereon. Upon execution of the instruction by the at least one processor, the system may monitor financial transactions for a user, and identify, based at least partially on the financial transactions, one or more user services associated with one or more reoccurring financial transactions. The system may also determine an amount of user activity associated with the one or more user services, and generate a recommendation based at least partially on the amount of user activity associated with the one or more user services. Further, the system may provide the recommendation to the user.

According to other embodiments, a non-transitory computer-readable media storing instructions thereon that, when executed by at least one processor, cause the at least one processor to perform a number of acts. The number of acts may include receiving spending data from at least one first third-party system, wherein at least a portion of the spending data is indicative of a reoccurring transaction for a service for a user. The number of acts may also include determining an amount of activity by the user associated with the service. Further, the number of acts may include generating at least one recommendation for the user at least partially based on the amount of activity. Moreover, the number of acts may include displaying, via a user interface, the at least one recommendation.

The foregoing specification is described with reference to specific example embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

The embodiments of the disclosure described above and illustrated in the accompanying drawing figures do not limit the scope of the disclosure, since these embodiments are merely examples of embodiments of the disclosure, which is defined by the appended claims and their legal equivalents. Any equivalent embodiments are intended to be within the scope of this disclosure. Indeed, various modifications of the present disclosure, in addition to those shown and described herein, such as alternative useful combinations of the content features described, may become apparent to those skilled in the art from the description. Such modifications and embodiments are also intended to fall within the scope of the appended claims and legal equivalents.

What is claimed is:

1. A method comprising:
monitoring spending data for a user in substantially real time;
identifying, based at least partially on the spending data, one or more reoccurring financial transaction events;
identifying one or more user services based on the one or more reoccurring financial transaction events;
determining an amount of user activity for the user related to at least one user service of the one or more user services;
generating a recommendation related to the at least one user service based at least partially on the determined amount of user activity; and
providing the recommendation to the user.

2. The method of claim 1, further comprising:
tracking a geolocation of the user; and
correlating the geolocation of the user and the reoccurring financial transaction events.

3. The method of claim 2, wherein generating the recommendation is further based at least partially on the correlation of the geolocation of the user and the reoccurring financial transaction events.

4. The method of claim 2, wherein generating the recommendation comprises generating the recommendation to cancel the at least one user service responsive to determining that the user is not using the at least one user service at a minimum threshold level.

5. The method of claim 4, further comprising adjusting the minimum threshold level responsive to one or more of the spending data, the determined amount of user activity, or the geolocation of the user.

6. The method of claim 1, wherein the monitoring the spending data comprises tracking transaction data for at least one of a credit card or a debit card over a period of time.

7. The method of claim 1, further comprising canceling the at least one user service responsive to the determining that the user does not sufficiently use the at least one user service.

8. A system, comprising:
at least one processor; and
at least one non-transitory computer-readable storage media storing instructions thereon that, when executed by the at least one processor, cause the system to:
monitor financial transactions for a user;
identify, based at least partially on the financial transactions, one or more user services associated with one or more reoccurring financial transactions;
determine an amount of user activity associated with the one or more user services;
generate a recommendation based at least partially on the amount of user activity associated with the one or more user services; and
provide the recommendation to the user.

9. The system of claim 8, wherein the amount of user activity comprises an amount of time spent using a service corresponding to the one or more user services.

10. The system of claim 8, wherein the amount of user activity comprises a number of visits that the user made to a location corresponding to a user service of the one or more user services.

11. The system of claim 8, wherein the at least one non-transitory computer-readable storage media further includes instructions that, when executed by the at least one processor, further cause the system to:
monitor a geolocation of a mobile device associated with the user; and
analyze the monitored geolocation to determine a frequency and a duration of visits of the mobile device to one or more locations associated with the one or more user services.

12. The system of claim 11, further comprising correlating the monitored financial transactions, the one or more user services, and the monitored geolocation to determine spending habits for the user related to the one or more user services.

13. The system of claim 11, wherein the recommendation is determined and provided to a mobile device by further analyzing the monitored geolocation.

14. The system of claim 13, wherein the recommendation is determined and provided to the mobile device responsive to a determination that one or both of the frequency or the duration of visits to a location associated with a user service of the one or more user services is below a minimum threshold.

15. A non-transitory computer-readable media storing instructions thereon that, when executed by at least one processor, cause the at least one processor to perform acts comprising:
receiving spending data from at least one first third-party system, at least a portion of the spending data indicating a reoccurring transaction for a service for a user;
determining an amount of activity by the user associated with the service;
generating at least one recommendation for the user at least partially based on the amount of activity; and
displaying, via a user interface, the at least one recommendation.

16. The non-transitory computer-readable media of claim 15, further comprising instructions thereon that, when executed by the at least one processor, cause the at least one processor to further perform an act of generating location data comprising a geolocation of the user over a period of time.

17. The non-transitory computer-readable media of claim 16, wherein the at least one recommendation for the user is at least partially further based on the location data.

18. The non-transitory computer-readable media of claim 15, wherein the at least one recommendation is at least partially based on a determination that the amount of activity does not meet a minimum threshold when compared to a cost of the service.

19. The non-transitory computer-readable media of claim 15, further comprising instructions thereon that, when executed by the at least one processor cause the at least one processor to further perform an act of canceling the service responsive to a determination that the amount of activity does not meet a minimum threshold when compared to a cost of the service.

20. The non-transitory computer-readable media of claim 15, wherein the recommendation comprises at least one of:
a recommendation to increase use of the service;
a recommendation to decrease a cost of the service; or
a recommendation to cancel the service.
